(19) United States
(12) Patent Application Publication
(10) Pub. No.: US 2007/0006241 A1
(43) Pub. Date: Jan. 4, 2007

(54) DISK RECORDING/READING APPARATUS

(76) Inventors: Wen-Hong Wang, Taipei City (TW); Shih-Lin Yeh, Taipei City (TW); Jui-Nan Chuang, Taipei City (TW); Jeng-Jiun Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,790

(22) Filed: Sep. 22, 2005

(30) Foreign Application Priority Data
Jun. 30, 2005 (TW) 94122070

(51) Int. Cl. G11B 17/04; G11B 33/08; G11B 17/03; G11B 33/14; G11B 33/02

(52) U.S. Cl. 720/611; 720/651

(57) ABSTRACT

A disk recording/reading apparatus for recording/reading a disk is provided. The disk recording/reading apparatus includes a case, a tray, a turntable and an optical pickup unit. The tray is inside the case and has a concave trough and a concave trough extension portion. The concave trough is used for accommodating a disk, and the concave trough extension portion stretches from the concave trough to a side of the tray front end and has an opening passing through the tray. The turntable is disposed below the tray for driving the disk. Wherein, at least a spinning airflow below the disk is suitable for being expelled from the opening of the concave trough extension portion to reduce the noise caused by air turbulence and the vibration during disk spin.

### CROSS-REFERENCE TO RELATED APPLICATION

This application claims the priority benefit of Taiwan application serial no. 94122070, filed on Jun. 30, 2005. All disclosure of the Taiwan application is incorporated herein by reference.

### BACKGROUND OF THE INVENTION

1. Field of Invention

The present invention relates to a disk recording/reading apparatus, and particularly to a disk recording/reading apparatus capable of effectively reducing airflow noise during disk spin.

2. Description of the Related Art

With such advantages as cheap price, portability, enormous memory capacity, easy storage, long storage period, low cost and resistance to data damage, optical disks are gradually replacing the conventional magnetic storage medium and have become an indispensable optical storage medium for modern people today. Due to wide applications of optical disks, optical disk drives for reading disk data have become a common electronic product in the modern life as well.

FIG. 1A is a schematic structure diagram of a conventional optical disk drive. Referring to FIG. 1A, a conventional optical disk drive 100 includes a case 110, a tray 120, a reading module 130 and a clamping element 140, and all these are disposed inside the case 110. Wherein, the case 110 is suitable for protecting the components inside the optical disk drive 100. The tray 120 is suitable for ejecting and carrying the disk 10. The reading module 130 is suitable for reading data on the disk 10. Besides, the reading module 130 includes a guide rail 132 and an optical pickup 134. The clamping element 140 and a turntable (not shown) hold the disk 10 together, so that the turntable is able to drive the disk to spin.

To read data on the disk 10 with the optical disk drive 100, at first, the disk 10 is placed on the tray 120 and the tray 120 with the carried disk 10 together slide into the case 110. Next, the turntable rises and then with the clamping element 140, together holds the disk 10. Further, the turntable drives the disk 10 to spin at a proper spinning speed, while the optical pickup 134 along the guide rail 132 traverses back and forth for reading data on the disk 10.

As the disk 10 spins at a high speed, the rotation speed of the disk 10 can reach 10,000 RPM, which produces an airflow in the optical disk drive 100. However, the flow speed field at each region inside the optical disk drive 100 is different from each other, which results in uneven pressure inside the optical disk drive 100. FIG. 1B is a top view of the conventional optical disk drive in FIG. 1A in operation. The pressures at the regions indicated in a, b, c and d are higher than other non-indicated regions theoretically. Since the rear region of the tray 120 has a bigger space and there is an opening on the rear area of the tray 120 for accommodating the optical pickup 134 to read data on the disk 10, the airflow produced at the rear region of the tray 120 can be expelled through the rear space or the above-mentioned opening. The air pressures at the rear regions of the tray 120 are released. Therefore, the air pressures at the front regions of the tray 120, a and b, are higher than which at the rear regions of the tray 120, c and d. Such uneven air pressures inside the optical disk drive 100 would form air turbulence, further lead to increasing vibration and noise during operation.

To overcome the above-described disadvantage, another conventional optical disk drive is development which is capable of improving uneven inner pressure. FIG. 2A is a schematic structure diagram of another conventional optical disk drive. Referring to FIG. 2A, the optical disk drive 200 is quite similar to the disk drive 100. The unique feature of the optical disk drive 200 is that at a front end 220a of a tray 220 in the optical disk drive 200, two airflow guiding openings 222 are made, which allow the airflow in the front region of the tray 220 to be expelled such that the air pressure difference inside the optical disk drive 200 is accordingly decreased. FIG. 2B is a top view of the conventional optical disk drive in FIG. 2A in operation. Referring to FIG. 2B, it shows in more details there are two airflow guiding openings 222 disposed just at the local regions, a and b, respectively, for the airflow to be expelled therefrom, which helps decrease air pressure therein. FIG. 2C is a cross-sectional view along plane A-B of the conventional optical disk drive in FIG. 2B in operation. Referring to FIG. 2C, the airflow path at the front region of the tray 220 can be seen in the figure, where an airflow guiding openings 222 serves as an outlet for the expelled airflow. Since the disk 10 is supported upwards by the turntable during operation, there is a space between the disk 10 and the tray 220. Therefore, there is another airflow produced below the disk 10 when the disk 10 is running. The airflow guiding openings 222 only allow the airflow above the disk 10, not the airflow below the disk 10, to be expelled, which still causes uneven air pressure difference between the regions above and below the disk 10 and generates an air turbulence. As the disk 10 spins, the air turbulence makes even greater vibration and noise.

### SUMMARY OF THE INVENTION

Based on the above described, an object of the present invention is to provide a disk recording/reading apparatus capable of effectively reducing vibration and noise during disk spin.

According to the above-mentioned object or the others, the present invention provides a disk recording/reading apparatus used for recording and reading a disk. The disk recording/reading apparatus includes a case, a tray, a turntable and an optical pickup unit (OPU). The tray is disposed inside the case and has a concave trough and a concave trough extension portion, wherein the concave trough is used for placing the disk, the concave trough extension portion stretches from the concave trough to a side of the tray front end, and the concave trough extension portion further contains an opening passing through the tray. The turntable is disposed below the tray for driving the disk, wherein at least a spinning airflow below the disk is suitable for being expelled from the opening of the concave trough extension portion. In addition, the optical pickup unit (OPU) is disposed in the case as well and is used for recording/reading the data on the disk.

According to the disk recording/reading apparatus of the embodiment, at least an airflow above the disk is able to be expelled from the opening of the concave trough extension portion.

According to the disk recording/reading apparatus of the embodiment, the tray has a first front end and a second front end, while the concave trough extension portion stretches, for example, from the concave trough to the first front end.

According to the disk recording/reading apparatus of the embodiment, the tray includes, for example, an airflow guiding opening disposed in the second front end of the tray such that at least an airflow above the disk is able to be expelled from the airflow guiding opening.

According to the disk recording/reading apparatus of the embodiment, the optical pickup unit (OPU) includes, for example, an optical pickup head, which can emit a first light signal onto the disk and receive a second light signal reflected from the disk.

Based on the above described, the tray of the disk recording/reading apparatus in the embodiment has a concave trough extension portion used for the airflows above and below the disk to be expelled, which is capable of reducing vibration and noise during disk spin.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1A is a schematic structure diagram of a conventional optical disk drive.

FIG. 1B is a top view of the conventional optical disk drive in FIG. 1A in operation.

FIG. 2A is a schematic structure diagram of another conventional optical disk drive.

FIG. 2B is a top view of the conventional optical disk drive in FIG. 2A in operation.

FIG. 2C is a cross-sectional view along plane A-B of the conventional optical disk drive in FIG. 2B in operation.

FIG. 3A is a schematic structure diagram of a disk recording/reading apparatus according to the first embodiment of the present invention.

FIG. 3B is a top view of the disk recording/reading apparatus in FIG. 3A in operation.

FIG. 3C is a cross-sectional view along plane A-B of the disk recording/reading apparatus in FIG. 3B in operation.

FIG. 4A is a schematic structure diagram of a disk recording/reading apparatus according to the second embodiment of the present invention.

FIG. 4B is a top view of the disk recording/reading apparatus in FIG. 4A in operation.

FIG. 4C is a cross-sectional view along plane A-B of the disk recording/reading apparatus in FIG. 4B in operation.

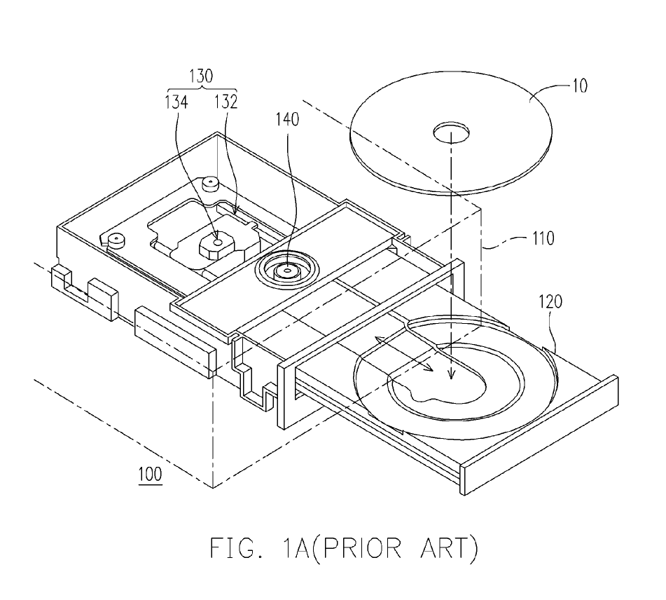

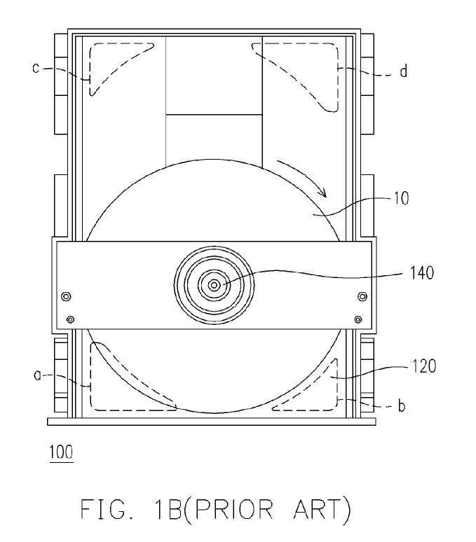

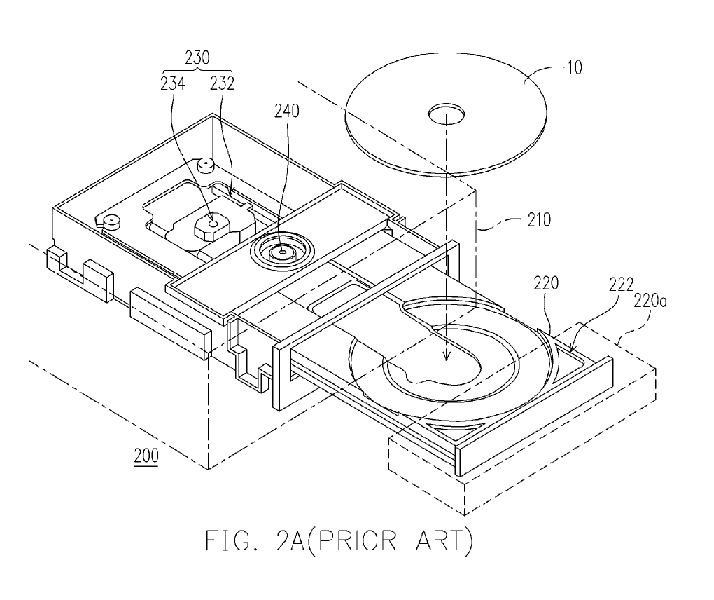

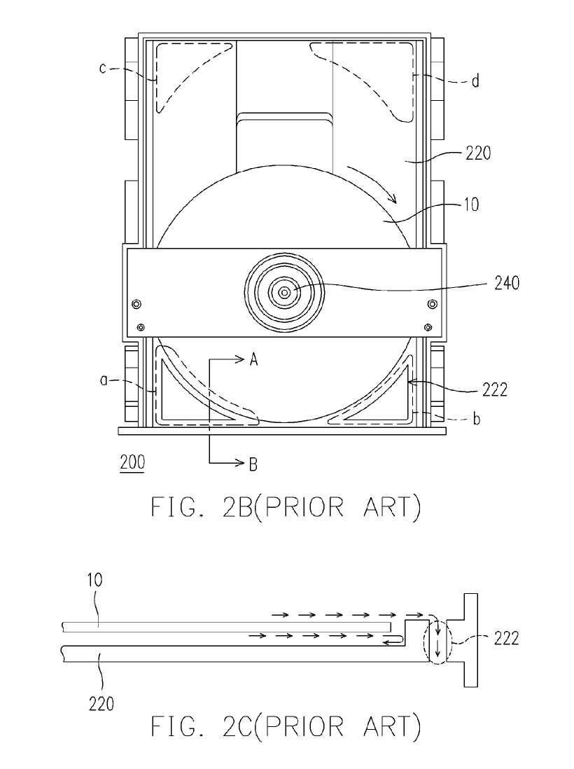

### DESCRIPTION OF THE EMBODIMENTS

### First Embodiment

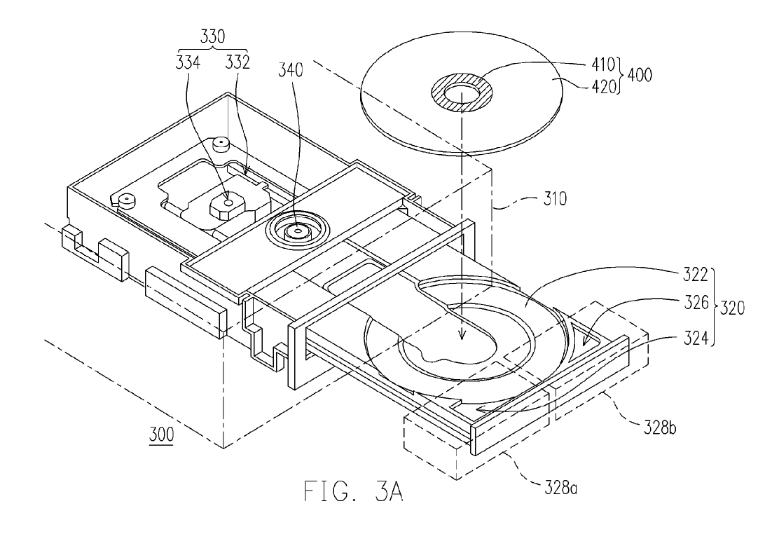

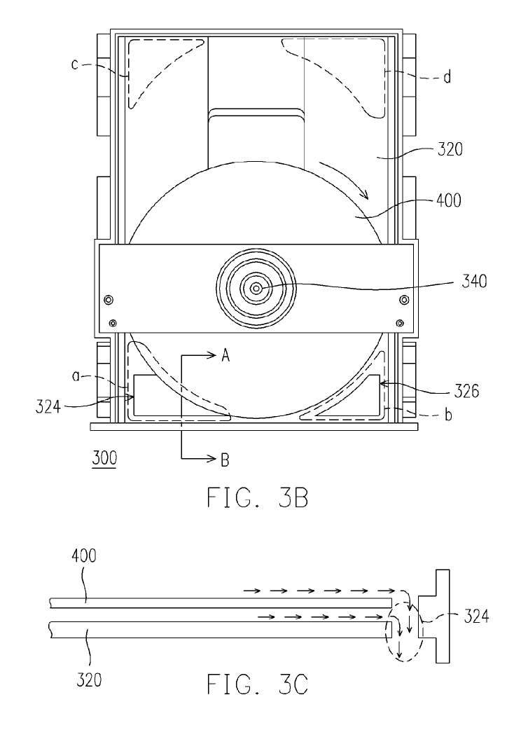

FIG. 3A is a schematic structure diagram of a disk recording/reading apparatus according to the first embodiment of the present invention. Referring to FIG. 3A, the disk recording/reading apparatus 300 in the embodiment is, for example, an optical disk drive, a disk burner, a DVD ( digital versatile disc) player or a DVD burner and used for recording/reading a disk 400. The disk 400 includes a hub (clamping area) 410 and a data area 420. The data area 420 is located at a region outside the hub 410, and the disk 400 spins around the center of the hub 410. The disk recording/reading apparatus 300 includes a case 310, a tray 320, an optical pickup unit (OPU) 330 and a clamping element 340, wherein the tray 320, the OPU 330 and the clamping element 340 are disposed inside the case 310.

The tray 320 has a concave trough 322, a concave trough extension portion 324 and an airflow guiding opening 326. The concave trough 322 is used for placing the disk 400. The front region of the tray 320 and beyond the concave trough 322 is divided into a first front end 328a and a second front end 328b. In the embodiment, the concave trough extension portion 324 stretches from the concave trough 322 to the first front end 328a of the tray 320. The airflow guiding opening 326 is located in the second front end 328b of the tray 320 and takes a shape much like trapezium, triangle, or others. In addition, the concave trough extension portion 324 has an opening passing through the tray 320 and connected to the outside of the concave trough 322, and the opening has a shape much like trapezium. In another embodiment, the opening of the concave trough extension portion 324 has a shape much like triangle or others.

Since the disk can spin at two different rotary directions, in the two local regions at both sides of the tray front end, the air pressure accordingly varies. FIG. 3B is a top view of the disk recording/reading apparatus in FIG. 3A in operation. Referring to FIG. 3B, a top view of the disk recording/reading apparatus 300 is shown. The disk 400 in the embodiment spins at clockwise direction, for example, which makes the produced airflow also flow clockwise and causes a higher air pressure in the region a of the tray front end than the pressure in the region b. In the embodiment, the above-mentioned first front end 328a is located in the region a of the front end of the tray 320 with higher air pressure. In addition, the concave trough extension portion 324 stretches from the concave trough 322 where the disk is located to the first front end 328a. In other words, according to the rotary direction of the disk 400, the concave trough extension portion 324 is accordingly disposed at a side of the tray front end with a higher air pressure. In the other embodiments, however, the tray 320 can have a pair of concave trough extension portions 324, which stretch from the front end of the tray 320 to both sides thereof, respectively.

Referring to FIG. 3A again, the optical pickup unit (OPU) 330 includes an optical pickup head 334 and a guide rail 332. The optical pickup head 334 is, for example, a laser pickup and able to traverse back and forth along the guide rail 332 at the radial direction of the disk 400. The optical pickup head 334 is used for emitting a first light signal onto the data area 420 of the disk 400 and receiving a second light signal reflected from the data area 420.

The turntable (not shown) is located below the tray 320 and with the clamping element 340, together holds the hub 410 of the disk 400, so that the disk 400 is driven by the turntable to spin.

To read the data on the disk 400 with the disk recording/reading apparatus 300, at first, the disk 400 is placed on the tray 320, which with the carried disk 400 together slides into the case 310. Next, the turntable rises and then with the clamping element 340, together holds the hub (clamping area) of the disk 400. The clamping element 340 is generally an iron piece, and a magnet is disposed in the turntable. As the turntable rises, the clamping element 340 is attracted by the turntable, so that the disk 400 between the turntable and the clamping element 340 is clamped. Further, the turntable drives the disk 400 for spinning at a proper spinning speed, while the optical pickup head 334 would emit a first light signal onto the data area 420 of the disk 400 and receive a second light signal reflected from the data area 420. While the optical pickup head 334 traverses back and forth along the guide rail 332, the optical pickup unit (OPU) 330 receives a reading command or a writing command for reading data or recording data on the disk 400.

Note that as an user is writing data on the disk 400 with the disk recording/reading apparatus 300, the optical pickup head 334 would emit a light beam in higher power onto the data area 420 of the disk 400, so that the material on the data area 420 of the disk 400 generate structural change for recording data. When reading data on the disk 400 with the disk recording/reading apparatus 300, the optical pickup head 334 would emit a light beam in lower power onto the data area 420 of the disk 400, and then receive the light signal reflected from the data area 420 of the disk 400 for reading data.

FIG. 3C is a cross-sectional view along plane A-B of the disk recording/reading apparatus in FIG. 3B in operation. Referring to FIG. 3B and 3C, as the disk 400 spins at a rotary speed of, for example, 10,000 RPM, inside the disk recording/reading apparatus 300, an airflow is produced. The pressures at the regions indicated in a, b, c and d in FIG. 3B are higher than other non-indicated regions. Further, the disk 400 spins at clockwise direction in the embodiment, which causes a higher air pressure in the region a than the pressure in the region b. To reduce the pressure in the region b, an airflow guiding opening 326 is made in the second front end 328b of the tray 320, so that the airflow above the disk 400 and in the region b can be expelled from the airflow guiding opening 326, which results in a smaller pressure difference between the region b and other non-indicated regions. Besides, to effectively reduce the pressure in the region a, a concave trough extension portion 324 stretches from the concave trough 322 to the first front end 328a of the tray 320, so that the airflow above the disk 400 and in the region a can be expelled from the concave trough extension portion 324, which results in a smaller pressure difference between the region a and other non-indicated regions. Since the pressure of below the disk 400 in the region a is higher than which in the region b, the concave trough extension portion 324 is designed to be connected to the concave trough 322, which reduces the pressure difference between the upper region of the disk 400 and the lower region thereof. In other words, the disposed concave trough extension portion 324 allows the airflow above the disk 400 moving toward the region a to be expelled from the concave trough 322 to the concave trough extension portion 324. Meanwhile, the airflow below the disk 400 moving toward the region a is able to be expelled from the concave trough 322 to the concave trough extension portion 324. In addition, the airflow guiding opening 326 located in the second front end 328b of the tray 320 allows the airflow above the disk 400 moving toward the region b to be expelled from the concave trough 322 to the airflow guiding opening 326.

From the above described, the concave trough extension portion 324 and the airflow guiding opening 326 serve for guiding airflow and reducing the pressure difference between the regions a and b inside the disk recording/reading apparatus 300 and other non-indicated regions, which ameliorates the air turbulence and reduces the noise produced by airflow. Besides, along with a reduced pressure difference between the upper region and the lower region of the disk 400, the vibration and noise during operation of the disk 400 is reduced as well.

### Second Embodiment

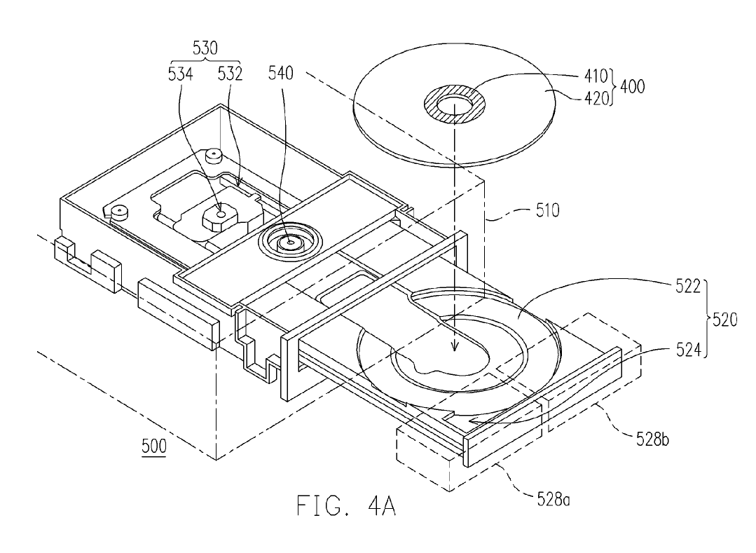

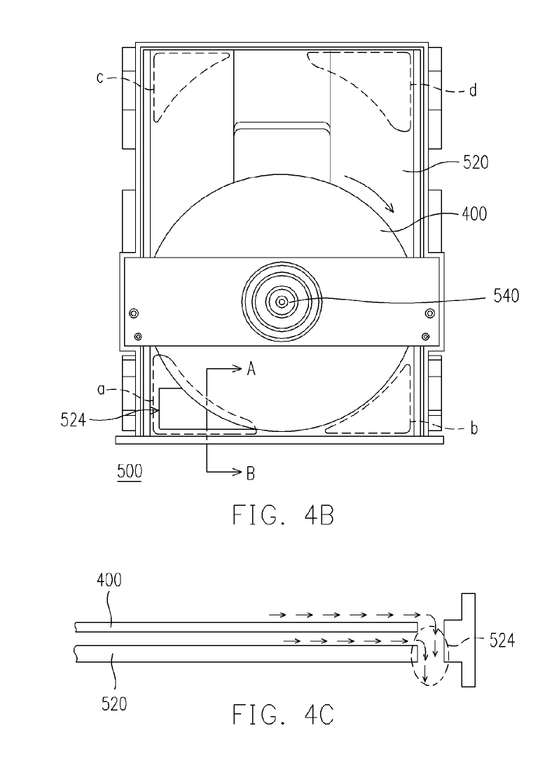

FIG. 4A is a schematic structure diagram of a disk recording/reading apparatus according to the second embodiment of the present invention. FIG. 4B is a top view of the disk recording/reading apparatus in FIG. 4A in operation. FIG. 4C is a cross-sectional view along plane A-B of the disk recording/reading apparatus in FIG. 4B in operation. Referring to FIGS. 4A-4C, the disk recording/reading apparatus 500 of the embodiment is similar to the disk recording/reading apparatus 300 in the first embodiment, except for a unique feature that in the disk recording/reading apparatus 500 of the embodiment, there is no airflow guiding opening 326. The tray 520 of the disk recording/reading apparatus 500 has a concave trough 522 and a concave trough extension portion 524. The front region of the tray 520 and beyond the concave trough 522 is divided into a first front end 528a and a second front end 528b. In the embodiment, the concave trough extension portion 524 stretches from the concave trough 522 to the first front end 528a of the tray 520. In addition, the concave trough extension portion 524 has an opening with a shape much like trapezium, and the opening runs through the tray 520 and is connected to the periphery of the concave trough 522.

As the disk 400 spins at a high speed, to reduce the pressure in the region a, the concave trough extension portion 524 is designed to stretch from the concave trough 522 to the first front end 528a of the tray 520, so that the airflows above and below the disk 400 can be expelled from the concave trough extension portion 524. Thus, the pressure differences between the region a and other non-indicated regions and between the upper region and the lower region of the disk 400 are reduced.

From the above described, the concave trough extension portion 524 serves for guiding the airflow and reducing the pressure difference between the regions a inside the disk recording/reading apparatus 500 and other regions, which ameliorates the air turbulence and reduces the noise produced by the airflow. Besides, along with a reduced pressure difference between the upper region and the lower region of the disk 400, the vibration and noise during operation of the disk 400 is reduced as well.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A disk recording/reading apparatus, suitable for recording/reading data on a disk, the disk recording/reading apparatus comprising:
a case;
a tray, disposed inside the case, having a concave trough for placing the disk and a concave trough extension portion stretching from the concave trough to a side of the tray front end and having an opening passing through the tray;
a turntable, disposed below the tray, for driving the disk to spin, wherein at least a spinning airflow below the disk is suitable for being expelled from the opening of the concave trough extension portion; and
an optical pickup unit, disposed inside the case, for recording/reading the data on the disk.

2. The disk recording/reading apparatus as recited in claim 1, wherein at least a spinning airflow above the disk is suitable for being expelled from the opening of the concave trough extension portion.

3. The disk recording/reading apparatus as recited in claim 1, wherein the tray comprises a first front end and a second front end, and the concave trough extension portion stretches from the concave trough to the first front end.

4. The disk recording/reading apparatus as recited in claim 3, wherein the tray further comprises an airflow guiding opening disposed in the second front end of the tray, such that at least a spinning airflow above the disk is suitable for being expelled from the airflow guiding opening.

5. The disk recording/reading apparatus as recited in claim 1, wherein the optical pickup unit comprises an optical pickup head, and the optical pickup head emits a first light signal onto the disk and receives a second light signal reflected from the disk.
